(19) United States
(12) Patent Application Publication
(10) Pub. No.: US 2009/0094993 A1
(43) Pub. Date: Apr. 16, 2009

(54) LNG By-Pass for Open Rack Vaporizer During LNG Regasification

(75) Inventor: Lin Chaio Hsu, Houston, TX (US)

Correspondence Address: CHEVRON CORPORATION, P.O. BOX 6006, SAN RAMON, CA, 94583-0806, US

(73) Assignee: Chevron U.S.A. Inc.

(21) Appl. No.: 12/337,516

(22) Filed: Dec. 17, 2008

Related U.S. Application Data
(63) Continuation of application No. 11/265,452, filed on Nov. 1, 2005.

(51) Int. Cl. F17C 9/02

(52) U.S. Cl. 62/50.2

(57) ABSTRACT

A process for vaporizing liquefied natural gas that is at a temperature of −220° F. or below which comprises (a) passing a first liquefied natural gas stream through an open rack vaporizer which uses a heat transfer agent which comprises water under conditions which will raise the liquefied natural gas to a temperature sufficient to vaporize the liquefied natural gas while lowering the temperature of the heat transfer medium by no more than 30° F.; (b) recovering a vaporized natural gas stream at a temperature T¹ from the open rack vaporizer; (c) combining the vaporized natural gas stream recovered in step (b) with a second liquefied natural gas stream to form a natural gas vapor stream which has a temperature T² that is lower than temperature T¹.

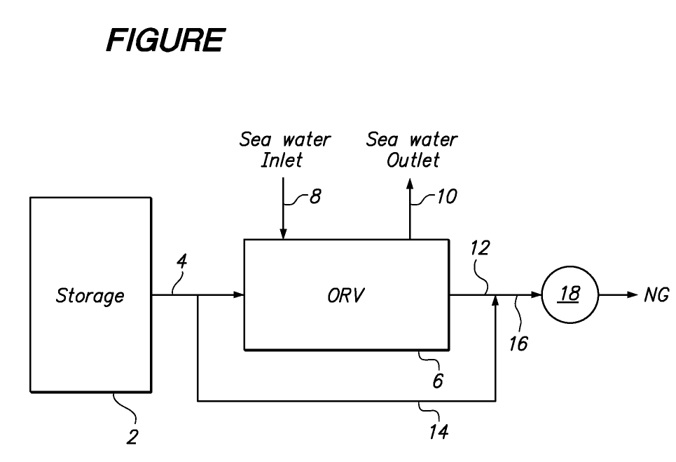

This application is a continuation of and claims priority to application Ser. No. 11/265,452, filed Nov. 1, 2005. This application claims priority to and benefits from the foregoing, the disclosure of which is incorporated herein by reference.

### FIELD OF THE INVENTION

The present invention is directed to the use of an open rack vaporizer in the regasification of liquefied natural gas.

### BACKGROUND OF THE INVENTION

Open rack vaporizers, often referred to as an ORV, are widely used for the regasification of liquefied natural gas (LNG) at LNG receiving terminals. In the open rack vaporizer the source of heat used to warm the LNG to its bubble point is usually fresh water, supplied from a river or lake, or sea water. In some ORV designs the fresh water or sea water may also be used to heat an intermediate heat transfer fluid, such as propane, and then the intermediate heat transfer fluid is used to perform the actual vaporization. The use of an intermediate heat transfer fluid prevents the problem of the water freezing when it comes into contact with the cold LNG heat transfer surface. However, using direct heat exchange between the water and the LNG results is a fairly simple efficient operation if the ORV is properly designed.

Since most LNG receiving terminals are located on the coast, sea water is present in virtually unlimited supply at the desired temperature, with minimum fluctuation in temperature over a period of months. The cooled sea water is returned to the sea for re-equilibration with the bulk of water. However, in practice there are usually strict regulated limits for both the volume of sea water that may used and the amount of cooling permitted for sea water during heat exchange with the LNG. As an example, the sea water returned to the sea following exchange with the LNG may be limited to a temperature of no more than 20° F. less than the sea water temperature prior to exchange. Generally, the open rack vaporizer is designed for operation at the lowest expected water temperature, i.e., during the winter months. Thus during periods when the sea water temperature is above the minimum, the natural gas vapor leaving the vaporizer will be superheated when produced at design flow rates. It is desirable to have a regasification process which utilizes this additional heat to increase the volume of LNG which is regasified.

As used in this disclosure the words “comprises” or “comprising” are intended as open-ended transitions meaning the inclusion of the named elements, but not necessarily excluding other unnamed elements. The phrases “consists essentially of” or “consisting essentially of” are intended to mean the exclusion of other elements of any essential significance to the composition. The phrases “consisting of” or “consists of” are intended as a transition meaning the exclusion of all but the recited elements with the exception of only minor traces of impurities.

### SUMMARY OF THE INVENTION

In its broadest aspect the present invention is directed to a process for vaporizing liquefied natural gas that is at a temperature of −220° F. or below which comprises (a) passing a first liquefied natural gas stream through an open rack vaporizer which uses a heat transfer agent which comprises water under conditions which will raise the liquefied natural gas to a temperature sufficient to vaporize the liquefied natural gas while lowering the temperature of the heat transfer medium by no more than 30° F.; (b) recovering a vaporized natural gas stream at a temperature T¹ from the open rack vaporizer; (c) combining the vaporized natural gas stream recovered in step (b) with a second liquefied natural gas stream to form a natural gas vapor stream which has a temperature T² that is lower than temperature T¹. The open rack vaporizer may use the water directly as a heat exchange fluid or may use an intermediate heat transfer fluid, such as propane, to heat the LNG. As used in this embodiment “water” refers to a heat exchange fluid which is predominately water, such as fresh water, sea water, or brackish water. Accordingly the water may contain various solutes and other impurities, either naturally occurring or added. The source of the water is generally a naturally occurring body of water, such as the ocean, sea, bay, river, or lake that is large enough to provide sufficient water to meet the needs of the regasification facility.

The temperature T² of the natural gas vapor stream is generally the temperature at which the natural gas enters the distribution grid. The temperature T¹ is the temperature at which the vaporized natural gas is recovered from the ORV. The present invention makes it possible to increase the amount of LNG that can be regasified with the same amount of water without lowering the temperature of the water discharge below an unacceptable level. It also allows the ORV to be operated at design capacity during warm periods without significantly increasing the amount of water needed to regasify the LNG.

Generally, the first liquefied natural gas stream and the second liquefied natural stream are recovered from a common source. That source may be a land based LNG storage facility such as, for example, an above ground LNG storage tank, an underground storage tank, or a naturally occurring underground storage cavern such as a salt dome. Alternately, the LNG storage facility may be located off-shore which includes, but is not necessarily limited to, a stationary fixed off-shore structure, a floating off-shore storage vessel such as a storage barge, or an LNG transportation vessel such as an LNG tanker ship.

### BRIEF DESCRIPTION OF THE DRAWING

The FIGURE is a diagrammatic representation of the process of the invention.

### DETAILED DESCRIPTION OF THE INVENTION

Liquified natural gas or LNG is primarily methane, but varying amounts of C₂+ hydrocarbons are almost always present. During storage at atmospheric pressure, LNG is maintained at a temperature below about −220° F., generally about −260° F. or less. Upon regasification the LNG must be raised above its bubble point. Since LNG almost always contains some C₂+ hydrocarbons, the temperature at which regasifiaction occurs usually involves a temperature range rather than a single point. In addition, the regasified LNG must not be heated to a temperature that is not compatible with the temperature and pressure of the natural gas present in the distribution grid to which the regasified LNG will be added. However, if the water used as a heat transfer medium is too warm, as may occur in the summer months for example, and the ORV is operated at design capacity, the regasified LNG will be superheated. The present invention is directed to a method for operating the ORV at design capacity without superheating the natural gas while at the same time not lowering the temperature of the water serving as the heat transfer fluid below an acceptable level at the time of its discharge.

The present invention will be more clearly understood by reference to the drawing. Illustrated is a LNG storage tank 2 in which the LNG is stored at about atmospheric pressure at a temperature below about −220° F. LNG is carried by line 4 to the open rack vaporizer 6 which uses seawater as a heat transfer medium. Seawater is shown entering the open rack vaporizer at a temperature T³ via seawater inlet 8 and leaving via seawater outlet 10 at temperature T⁴. The difference between T³ and T⁴ will depend on a number of factors, such as the initial temperature of the seawater (T³), the volume of seawater passing through the ORV, the volume of LNG being fed into to the ORV, the design of the of the ORV, and the like. Superheated natural gas vapor leaves the ORV via line 12 at temperature T¹. An LNG by-pass 14 carries LNG around the ORV where it is mixed with the superheated natural gas vapor in line 12 to yield a natural gas vapor stream having a temperature T². Line 16 carries the cooled natural gas to a booster pump 18 which increases the pressure to that equal to the distribution network. It will be noted that the superheated natural gas vapor is used to vaporize the LNG carried by the LNG by-pass 14. This arrangement makes it possible to increase the volume of LNG which is vaporized without increasing the amount the amount of water passing through the ORV.

In the embodiment illustrated by the drawing the LNG enters the ORV at substantially atmospheric pressure, and the mixing of the vaporized natural gas and the LNG flowing through the by-pass takes place at substantially atmospheric pressure. One skilled in the art will recognize that the pressure in the system usually will be slightly above atmospheric pressure due to the normal boil off of the LNG. However, if the natural gas vapor stream is to be placed into the commercial distribution grid, it must fist be pressurized to at least 500 psig, more typically to at least 1000 psig. In an alternate and preferred embodiment of the invention, the pressure of the LNG may be increased significantly above atmospheric pressure prior to entry into the ORV. In general. it is preferred to increase the pressure of the LNG entering the ORV rather than to increase the pressure of the natural gas vapor, since it is more economical to pump the liquid LNG than to pressurize the natural gas vapor using a compressor. In addition, the pressure of the LNG entering the ORV may be increased above atmospheric pressure and the pressure of natural gas vapor stream may be further increased prior to entry into the distribution network.

Open rack vaporizers are well known in the art and have been used commercially for vaporizing LNG for some time. Those skilled in the art will understand the design of the open rack vaporizer without a detailed explanation here. Essentially the LNG passes through a series of hollow fins which serve as heat transfer surfaces over which flow sheets of heat transfer fluid. The heat transfer fluid may be water or, in some designs, an intermediate heat transfer fluid is employed, such as propane. If an intermediate heat transfer fluid is used, the water does not directly contact the heat transfer surface containing the LNG, but the water is used to heat the intermediate heat transfer fluid which in turn is used to heat the LNG which is constantly re-circulated. While slightly more complex, the intermediate heat transfer fluid prevents the freezing of the water on the fins which would impede the transfer of heat across the fins and decrease the overall efficiency of the system.

What is claimed is:

1. A process for vaporizing liquefied natural gas that is at a temperature of −220° F. or below which comprises:
(a) passing a first liquefied natural gas stream through an open rack vaporizer which uses a heat transfer agent which comprises water under conditions which will raise the liquefied natural gas to a temperature sufficient to vaporize the liquefied natural gas while lowering the temperature of the heat transfer medium by no more than 30° F.;
(b) recovering a vaporized natural gas stream at a temperature T¹ from the open rack vaporizer;
(c) combining the vaporized natural gas stream recovered in step (b) with a second liquefied natural gas stream to form a natural gas vapor stream which has a temperature T² that is lower than temperature T¹.

2. The process of claim 1 wherein the heat transfer agent is sea water.

3. The process of claim 1 wherein the heat transfer agent is fresh water.

4. The process of claim 1 wherein the temperature of the heat transfer agent is lowered by no more than 25° F.

5. The process of claim 4 wherein the temperature of the heat transfer agent is lowered by no more than 20° F.

6. The process of claim wherein the open rack vaporizer uses an intermediate heat exchange fluid.

7. The process of claim 1 wherein the first liquefied natural gas stream is passed through the open rack vaporizer at a pressure of 15 psig or less.

8. The process of claim 7 wherein the first liquefied natural gas stream is passed through the open rack vaporizer at substantially atmospheric pressure.

9. The process of claim 8 wherein the vaporized natural gas stream recovered from the open rack vaporizer is combined with the second liquefied natural gas stream at substantially atmospheric pressure.

10. The process of claim 9 wherein the natural gas vapor stream formed in step (c) is pressurized to a pressure of at least 500 psig.

11. The process of claim 10 wherein the natural gas vapor stream is pressurized to a pressure of at least 1000 psig.

12. The process of claim 1 wherein the first liquefied natural gas stream is passed through the open rack vaporizer at super atmospheric pressure.

13. The process of claim 12 wherein the pressure of the first liquid natural gas stream and the second liquefied natural gas stream are increased to a pressure sufficient so that the pressure of the natural gas vapor stream is at least 500 psig.

14. The process of claim 7 wherein the pressure of the first liquid natural gas stream and the second liquefied natural gas stream are increased to a pressure sufficient so that the pressure of the natural gas vapor stream is at least 1000 psig.

15. The process of claim 1 wherein the first liquefied natural gas stream and the second liquefied natural gas stream are recovered from the same liquefied natural gas storage structure.

16. The process of claim 15 wherein the liquefied natural gas storage structure is selected from the group consisting of a land based storage facility, a stationary off-shore storage facility, a floating off-shore storage vessel, and an LNG transportation vessel.
